(19) United States
(12) Patent Application Publication
(10) Pub. No.: US 2026/0247080 A1
(43) Pub. Date: Aug. 20, 2026

(54) HAPTIC DEVICES

(71) Applicant: Light Field Lab, Inc., San Jose, CA (US)

(72) Inventors: Daniel Smalley, Provo, UT (US); Annie Laughlin; Elias Guanuna; Keaton Shurilla; Luke Johnson; Kyle Schvaneveldt; Jonathan Sean Karafin, San Jose, CA (US); Brendan Elwood Bevensee, San Jose, CA (US)

(21) Appl. No.: 18/865,327

(22) PCT Filed: May 12, 2023
(86) PCT No.: PCT/US2023/022149

§ 371 Date: Nov. 19, 2024

Related U.S. Application Data
(60) Provisional application No. 63/341,169, filed on May 12, 2022.

(51) Int. Cl. H04R 17/10; G08B 6/00; H04R 19/00

(52) U.S. Cl. CPC H04R 17/10; G08B 6/00; H04R 19/00; H04R 2400/03

(57) ABSTRACT

A haptic device that creates mechanical energy fields that can be felt but not heard. The haptic device provides annular array transducers that may be substantially transparent to visual light so they can be coupled with a wavefront display to allow a person to feel visual objects projected through it as holograms. A transparent array of annular array transducers may be controlled to provide steerable beams of mechanical energy fields to points in space using principles of interference and superposition.

### TECHNICAL FIELD

This disclosure is related to haptic devices, and specifically to haptics devices for outputting mechanical energy into three-dimensional space that can induce haptic sensation.

### BACKGROUND

Next generation optics and acoustics have typically received more attention than haptic technologies. This is partially due to the complexity of the human somatosensory system. Proprioception, kinesthetic info, temperature, pain, and texture among many others are all encompassed. Some can be stimulated via focused mechanical energy, such as ultrasound.

### SUMMARY

A haptic device that creates sound that you can feel but not hear. The haptic device provides transducers that may be substantially transparent to visual light so they can be coupled with a visual display which allows a person to feel visual objects projected through it.

In an embodiment, a haptic device is provided by an annular transducer array. The annular transducer array has a plurality of concentric transducer rings located in a surface, that are centered on a point, having an outermost, and an innermost transducer ring. The outermost and innermost transducer rings are each driven by circuitry operable to cooperatively provide a mechanical energy field toward a volume in space. In an embodiment, multiple additional concentric transducer rings are located between the outermost and innermost transducer rings.

In another embodiment, a haptic device is provided by an array of annular arrays, whereby the mechanical energy fields from different transducer rings in different annular arrays are selectively controlled to provide focused and/or directed mechanical energy fields toward points in space.

In another embodiment, a haptic device comprises a substrate, sidewalls extending from the substrate and defining a cavity, a membrane coupled to the sidewall and positioned over the cavity, and electrodes operable to apply a voltage across the membrane. The membrane is operable to vibrate due to a drive signal and to generate a mechanical energy field towards a focal point in space. In an embodiment, the electrodes form an annular array pattern on the membrane. In an embodiment, the haptic device is substantially transparent to light transmitted through it.

### BRIEF DESCRIPTION OF THE DRAWINGS

FIG. 1 is a schematic diagram illustrating a cross-sectional view of the structure of a capacitive micromachined ultrasonic transducer;

FIG. 2 is a schematic diagram illustrating a cross-sectional view of the structure of a piezoelectric micromachined ultrasonic transducer;

FIG. 3 is a photograph illustrating an embodiment of an array of concentric ring-shaped transducers; and

FIG. 4 illustrates computational modeling of a 20-ring annular array.

FIG. 5 is an exploded perspective schematic diagram of an exemplary PMUT annular array that provides multiple annular transducer elements that are arranged in concentric rings.

FIG. 6. is a schematic diagram providing a top view of an exemplary phased array showing a 1×6 array of annular arrays.

FIG. 7 is a schematic diagram providing an exemplary 3×3 grid array of annular transducers, with each transducer ring being individually connected to and controlled by a controller.

FIG. 8 shows a perspective sectioned diagram of sidewalls of an exemplary annular array.

FIG. 9 is a graph 900 from computer modeling total mechanical energy field against distance from the transducer annular array when operating outside and inside annular transducer rings of the annular transducer array design shown in FIG. 8.

FIG. 10 is a graph 1000 for an exemplary modeled design of total mechanical energy field in decibels on the y axis against driving frequency in Kilohertz on the x axis.

FIGS. 11A and 11B show perspective schematic diagrams of a 3×3 array of annular arrays 1100 with an illustration of three different exemplary focal points in space where tactile feedback may be transmitted.

FIG. 12 shows a perspective schematic diagram of a 3×3 array of annular arrays with an illustration of three other exemplary focal points in space where tactile feedback may be transmitted spatially and temporally coincident with a holographic image overlaid thereon.

### DETAILED DESCRIPTION

Haptic devices can be designed based on the fundamental principles of constructive and deconstructive interference of waves. Multiple waves which are in phase will constructively interfere and linearly add. Waves that are opposite in phase will negatively interfere and cancel out. By controlling the phase of a set of waves they can be made to interfere in a certain direction only, known as beam steering (or beamforming). Closely related to this is steering the waves to a point, creating a focal point. Thus, to create an appreciable focus the objective is to control the phase of many acoustic waves.

This can be accomplished through an ultrasonic phased array. In other words, a series of acoustic transducers with individually controllable phase. This has some similarities with technology on which holograms are predicated. For instance, a hologram works by either transmitting or reflecting light through a grooved surface with the differences in the surface retarding the phase of the electromagnetic waves. The resultant light waves will interfere in such a way as to reconstruct a 3D wavefront.

The elements in an ultrasonic phased array may be configured to have the desired phase delays in order to focus to a point. This time difference between elements is given by:

$${t}_{j} = ( d ! - {d}^{n} ) / c$$

where dj is the distance between the jth transducer and the focal point, do is the distance between the center and the focus, and c is the speed of sound. It is a simple calculation to convert these time differences to a phase difference but as will be discussed later, an example digital implementation inputs phase delays as a simple time value so it is left as above.

Haptic devices may be configured according to the principles herein to stimulate cutaneous texture sensations, or so called tactile, or vibrotactile sensation via focused ultrasound. A focused ultrasonic solution allows for contact-free interaction, no moving parts, and high resolution compared to other methods that use air pumps or laser heating of the skin. Furthermore, ultrasonic phased arrays can also integrate visual and auditory information. The earliest work in this area was performed in the 1970's which involved the sensitivity thresholds for different kinds of sensations on the hand using focused ultrasound. This work was further refined to determine that tactile sensation was the effect of the acoustic radiation force acting on mechanoreceptors in the skin.

Importantly, these mechanoreceptors are sensitive to change. Thus, a signal that is modulated via either simple amplitude modulation of the focal point at 100-200 Hz or through movement of the focal point, known as spatiotemporal modulation, may lower the detection threshold. A spatial modulation scheme can produce sensation based on the user's position relative to stationary waves, thus eliminating the noise associated with amplitude and spatiotemporal modulation techniques.

Other modulation schemes may also improve the intensity of the vibrotactile stimuli. It can be concluded that, in some embodiments, the minimum detection threshold for vibrotactile stimulation using simple amplitude modulation is 0.3 to 0.4 mN.

Ultrasonic phased array haptics have been commercialized by companies such as Ultrahaptics (now Ultraleap) but known solutions are limited by being opaque transducers, (i.e., they cannot pass light through them), and limited by being made of an array of single-ring or single-drum transducers that, by virtue of their single channel transducer architecture, do not provide constructive interference within from a single transducer unit.

Ultrasonic Annular Array. In an embodiment, an ultrasonic array can be constructed as an annular array. In an embodiment, an annular array comprises a single array of nested concentric ring-shaped transducers. Annular arrays allow for generating a single tactile focal point due to their high fill factor and focusing capabilities compared to other array designs, such as a hexagonally packed grid.

Parameters of an ultrasonic annular array. It should be appreciated that there are an immense number of parameters with regards to the fabrication of an ultrasonic annular array in accordance with the present disclosure. These include membrane thickness, drum size, drum depth, electrode shape, and array geometry, as well as materials science considerations. These will be discussed throughout this specification.

A MATLAB script can be written that calculates the fill factor and phase delays for an annular array. This can be used to determine the geometry for an annular array to optimize the fill factor. In an exemplary embodiment, the width of each ring may be selected to be 6 mm, and the width between rings as 1.1 mm for a seven-ring annular array design with individually phase-controllable rings. The electrode coverage of the annular array transducers may be smaller than the transducer drum area, the exact size usually being determined by finite element modeling. In an embodiment, electrodes may be configured with 67% coverage.

Annular Array Transducer Fabrication Techniques. A number of transducer fabrication techniques may be used to create the annular arrays of the present disclosure. In an embodiment, capacitive transducers, so called capacitive micro-machined ultrasonic transducers (“CMUTs”) may be used. CMUTs function somewhat similar to that of a parallel-plate capacitor.

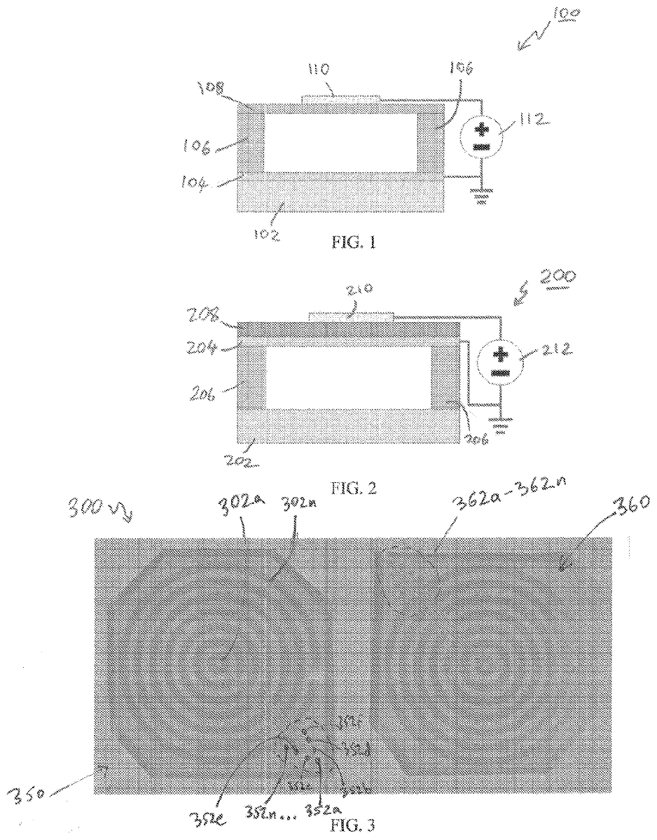

FIG. 1 is a schematic diagram illustrating a cross-sectional view of the structure of a capacitive micromachined ultrasonic transducer (CMUT) 100. CMUT 100 includes a top electrode 110 which is attached to a membrane 108 with a bottom electrode 104 attached to a substrate 102, arranged as shown. When a voltage is applied from a modulated voltage source 112 (e.g., frequency generator) between the top and bottom electrodes 110, 104 respectively, the membrane 108 deflects due to the generated electrostatic force creating the ultrasound.

CMUT Fabrication. A technique to fabricate a CMUT may be based on lithographically defined sidewalls made of SU-8 (a transparent epoxy-based negative photoresist) over an indium tin oxide coated glass or PET substrate. A thin sheet of SU-8 may be laminated on top of the sidewalls using a heated electronic laminator. In an embodiment, a non-transparent electrode may be deposited on top of the membrane using sputtering. The equation for the electrostatic force of a parallel plate capacitor or CMUT is:

$${F}_{elec} = \frac{{∈}_{o} {A V}^{2}}{{d}^{2}}$$

where ∈″ is the permittivity in the cavity, A is the transducer area, V is the voltage applied, and d is the distance between the electrodes. Because d has an inverse square relationship with the electrostatic force, increasing d has a dramatic effect on the electrostatic force generated. Excessively high voltages in the hundreds or thousands of volts would be needed to generate an appreciable pressure output.

In an embodiment, after successfully fabricating sidewalls on a wafer, sidewalls are fabricated on indium tin oxide-polyethylene terephalate (ITO-PET). A sheet of ITO-PET is taped to a wafer using Kapton tape and performed the same process as before. Initially, the SU-8 did not adhere to the ITO-PET and release from the membrane. Plasma etching the ITO-PET for two minutes at max power may increase the surface roughness of the ITO-PET and enable adhesion between the SU-8 sidewalls and the membrane. Once the sidewalls are fabricated, a top membrane may be created to encapsulate the sidewalls. Roll-lamination is a technique where a sheet of a membrane is adhered to another sheet using pressure and heat. A pressure of 0.35 MPa or 50 psi may be used for adequate lamination. An electric laminator (e.g., SKY—335R6) may be used to provide adequate control of heat and speed. Roll-lamination may allow coverage of the cavities without filling them with reflowed SU-8. This also may enable lamination of membranes to the sidewalls. It was observed that many lamination experiments resulted in poor adhesion, non-uniform coverage, pressed sidewalls, and reverse lamination. Reverse lamination is where the sidewalls would be removed from the PET base and adhere to the membrane. This meant that the SU-8 preferentially adhered to itself over the PET. It should be noted that lamination problems may be solved by modifying the bake times, the process step ordering, lamination speed, and lamination temperature.

Operating a CMUT. In operation, in an embodiment, CMUTs may be driven with a large DC bias of 200 V-2000 V and an oscillatory voltage of 100 V-300 V. Bias tees, operational amplifiers, and a variety of circuitry may be used to modify existing power supplies and create a large AC power supply that was also capable of applying a DC bias. In an embodiment, a lower power supply may be used with a 40 V DC bias with an AC voltage of +−10 V. To determine the capacitance of the 100 μm diameter CMUTs, the capacitance equation may be used.

$$C = \frac{{∈}_{0} kA}{d}$$

where the separation distance d was 2 μm, and the relative permittivity k of air is 1. In an embodiment, the capacitance is determined to be 0.034 pF. A Polytec PSV-400 Laser Doppler Vibrometer (LDV) may be used to measure the vertical displacement. Using such equipment, the maximum displacement was around 1 nm. The collapse voltage was around 80 V for the measured samples and the resonance frequency was higher than the LDV could measure. It should be appreciated that a higher displacement may be achieved if the sample is driven near the collapse voltage and at its resonance frequency.

Design of a PMUT. In an embodiment, the transducers of the present disclosure may be fabricated using a piezoelectric transducer design, or piezoelectric micro-machined ultrasonic transducers (“PMUTs”).

FIG. 2 is a schematic diagram illustrating a cross-sectional view of the structure of a piezoelectric micromachined ultrasonic transducer (PMUT) 200. PMUT 200 differs from CMUT 100 in particular by the CMUT membrane being replaced with a piezoelectric element 208 or coupling one to it. In this exemplary embodiment, a PMUT 200 may include a piezoelectric element 208 between top electrode 210 and a bottom electrode 204, arranged as shown. When a voltage is applied from a modulated voltage source 112 (e.g., frequency generator) between the top and bottom electrodes 210, 204 respectively, the piezoelectric element 208 deflects due to the generated electrostatic force creating the ultrasound. The cavity depth becomes less of an issue in a PMUT (compared to a CMUT) as the voltage is applied to electrodes 204, 210, which are directly attached to the piezoelectric element 208. This design allows for a lower drive voltage requirement and no requirement for a DC bias.

The resonance frequency of a circular plate is:

$$f = \frac{α \sqrt{{D}_{E} / ρ h}}{2 π {r}^{2}}$$

here

$${D}_{E} = \frac{{Eh}^{3}}{1 - {v}^{2}}$$

and is the flexural rigidity, a is the resonance mode constant, r is the radius of the diaphragm, E is the effective Young's modulus, and the ρ is the effective density of the PMUT diaphragm, ν is Poisson's ratio, and h is the diaphragm thickness. Another technique of increasing the pressure output of a PMUT is decreasing the thickness of the diaphragm. The thinner the diaphragm results in increased PMUT displacements. Reducing the thickness also increases the bandwidth according to the following equation:

$$BW = \frac{{Z}_{air}}{2 {πρ}_{m} t}$$

Where Zₐᵢᵣ is the impedance of air and t is the thickness.

A significant advantage to micromachined transducers is that they can be monolithically integrated into electronic fabrication processes. Additionally, the sizes capable with cleanroom technology allow for high density, high frequency arrays that could produce a finer focal point and thus a higher resolution tactile hologram.

There are many piezoelectric elements available. Commercial transducers typically use an opaque material such as lead zirconate titanate (PZT). However, transparent piezoelectric materials are not commonly known. In an embodiment, it was found that polyvinylidenefluoride (PVDF) may be used as a piezoelectric element. PVDF is an piezoelectric polymer that may be used for this purpose due to its ability to be formed into thin clear sheets which can be used as the piezoelectric membrane element in PMUTs.

In an embodiment, thin films of PVDF may be fabricated via spin coating. The process is to dissolve powdered PVDF resin into N,N-dimethylformamide (DMF) and then spin coat it at a variety of speeds. PVDF exhibits polymorphism with the β phase offering the best piezoelectric qualities because of its comparatively high d33 constant which determines the piezoelectric response in the plane of interest. The spin speed may be controlled so that this phase is produced. Temperature and humidity are environmental factors that can be controlled to achieve the desired phase. When PVDF is produced it is subject to a polling process of many kilovolts that aligns the dipoles within the material and polarizes it. Thus, this may be accounted for in the fabrication of the PVDF film. Furthermore, because PVDF has a large dielectric constant this provides an upper limit for the driving voltage. In an embodiment, PVDF has a coercive field of 100 V/μm meaning that once that voltage is passed the PVDF will repolarize. For the 50 μm thick PVDF, this provides an upper driving limit of 5000 V, electrode considerations aside.

Making the Sidewalls of the Transducer. As illustrated in FIGS. 1 and 2, PMUTs and CMUTs may be suspended over cavities defining the drum of the transducer. The walls defining these drum depths are called sidewalls and a number of transparent sidewall fabrication methods may be used, including but not limited to, ultraviolet photolithography, 3D printing, and laser cutting.

As discussed above, SU-8 2000 photoresist may be used to create sidewalls of a CMUT. Hexagonally packed grid arrays were fabricated from sizes in the 100's of microns to 1 mm in diameter. Alternatively, SU-8 2008 photoresist, which is slightly more viscous, may be used to produce taller sidewalls. Photolithography may be used to produce low-profile transducers with favorable transparency. They also have the capacity to be integrated with other cleanroom fabrication processes making them desirable for commercial electronics integration. In an embodiment, they may be suitable for 1 mm or less drum sizes.

3D printed sidewalls can have feature sizes that go well below 1 mm and good transparency depending on the thickness of the substrate. They also offer a fast fabrication turnaround time compared to lithography. In an embodiment, a possible drawback is that flat substrates tend to warp in SLA resin printers. Additionally, the added support struts may leave pockmarks that reduce transparency. Transparency can be improved by either spraying or dipping the final print with a transparent resin. 3D printing offers a good balance between fabrication time, transparency, and resolution. For large transducers where resolution isn't as much of a concern, a laser cutting method may be used.

One relatively fast fabrication method for sidewalls is laser cutting acrylic. The resolution may be limited to no more than 1 mm, but for larger transducer drum sizes it is effective. Laser cut acrylic, however, may be hindered by its relative thickness, which reduces transparency.

Electrical Connections to transducers. To apply a voltage to each transducer element, two conductive electrodes are used. In an embodiment, a common ground electrode may be used, while the respective electrode for each annular transducer is patterned accordingly (as described, for example in FIG. 3). The deposition of transparent electrodes and patterning methods for three materials, silver nanowires (AgNW), poly(3,4-ethylenedioxythiophene) polystyrene sulfonate (PEDOT:PSS), and indium tin oxide (ITO) are disclosed as examples for fabricating the transducers of the present disclosure.

Silver nanowires (AgNW) are an aqueous solution of silver rods that are only a few nanometers in length. The aggregate mesh of small wire rods creates a conductive network. Thin electrode films with excellent resistance can be deposited via spray coating or dip coating. For increased conductivity, the silver nanowire density was increased which resulted in decreased transparency. For increased transparency, the density was decreased which resulted in increased sheet resistance. Silver nanowires have been shown to create electrodes with an average of 85% transmittance and their sheet resistances can be as low as 20Ω/□.

In an embodiment, the optimal dimensions for silver nanowires were diam.×L 30 nm (±5 nm)×20 μm (±3 μm). The optimal concentration was 0.3468 mg/ml of silver nanowires dispersed in isopropyl alcohol (IPA), and the most effective method to get a uniform, cross-linked coating was ultimately spray coating. Coated samples have one layer of SU-8 previously roll-laminated onto the sidewalls.

In an embodiment, the fabrications were performed by dip coating pieces of polyethylene terephthalate (PET) and glass in AgNW solution. Dip coating works by immersing the substrate in the solution and slowly pulling it out. As it is pulled out the solution dries at the liquid-air barrier leaving behind a thin conducting film. In an embodiment, silver nanowire dip coating may provide low sheet resistance electrodes, however, typically in localized regions. The sheet resistance was infinite in some regions and inhomogeneous in most other regions. In an embodiment, a spray coating machine can be used to uniformly distribute the silver nanowires over the substrate, prevent shorting between the top and bottom electrodes, prevent fluid from filling the cavities, reduce the amount of exposure to IPA, and increase transparency and uniformity.

In an embodiment, to create a uniform electrode that is flexible and conductive, the sample may be cross-linked. Cross-linking is when the silver nanowires are completely unaligned, overlapping, and stacked over one another to create many electrical paths and good electrical conduction. It resembles a micro game of pick-up sticks. Additional variables with the spray coater were the number of rasters, the injection rate, the scan speed, and the scan size. The higher number of rasters, the more the silver nanowires would overlap and the lower the sheet resistance. However, this was at the expense of transparency. The fewer the rasters, the higher the sheet resistance, and the lower the transparency. The used injection rate was 5 mL/hr. Typically, AgNW films are annealed to fuse the wire mesh and decrease the sheet resistance. This may be unsuitable for temperature sensitive PVDF films. Additionally, it may have comparatively high cost and a lack of reliable adhesion to a vibrating substrate.

PEDOT-PSS is a conductive polymer that is attractive due to its relatively low price and transparency, and it can be formed into gels. It can also be used to make thin conducting films. A variety of deposition methods exist including spray coating and inkjet printing. Lithographic methods exist but typically involve a high temperature annealing process which is not suitable for PVDF films. PEDOT:PSS typically is available as a colloidal solution of fine PEDOT:PSS particles suspended in water. To deposit it, a spray coating device may be used. In an embodiment, a spray coating device forces liquid through an ultrasonic sonicated nozzle that disperses the solution evenly. While the PEDOT:PSS solution comes in water, a diluent, such as IPA, may be added in order to reduce the viscosity so it can spray freely. In some circumstances, this process was unstable, and the spray coating device may become clogged due to a condition known as flocculation. If the solution did not have the proper ratio of liquids, then an unstable colloid would result and PEDOT:PSS particles would clump together and fall out of the solution.

The stability of a colloidal solution is determined by its zeta potential, which signifies the potential difference between the dispersion liquid and the particles in it:

$$ζ = \frac{η}{ϵ} μ$$

where ζ is the zeta potential, n is the viscosity and e is the dielectric constant of the solution, and u is the electrophoretic mobility of the particles. It was found that in order to maintain a high zeta potential and reduce flocculation, the viscosity should be relatively high and the dielectric constant should be relatively low. The viscosity couldn't be too low though, or the solution would not spray. In an embodiment, a solution of 1-1.3 wt % PEDOT:PSS in water and 10 wt % IPA allows for effective spraying to produce some high-quality films and the working transducer arrays using PVDF.

PEDOT:PSS naturally has a blue tint, but both the transparency and sheet resistance can be improved with different dispersion liquids and the use of surfactants. Its flexibility also makes it ideal as an electrode on vibrating membranes. In order to pattern electrodes via spray coating a shadow mask was used. While simple to produce, it is more difficult to fabricate small feature sizes with this technique.

It should be recognized that several fabrication techniques may be applied for maximizing transparency and minimizing sheet resistance when spin-coating PEDOT:PSS onto PVDF film. Such fabrication techniques include: 1) varying layers; 2) plasma etching; 3) post-treatment submersion in an Ethylene Glycol (EG) bath; and 4) adding EG and a surfactant to the PEDOT:PSS solution. In an embodiment, the PEDOT:PSS sheet resistance falls from over 3 M·Ohms/sq to between 600 and 150 ohms/sq depending on the number of layers. In an embodiment, a one-layer sample has a sheet-resistance of 600 ohms/sq and an optical transparency of about 75%, and the five-layer sample has a sheet-resistance of 150 ohms/sq and an optical transparency of about 50%.

Indium Tin Oxide is a transparent metal alloy popular for use in LCD displays due to the ease with which transparent thin conducting films can be deposited. It can be deposited via magnetron sputtering. PVDF films are also available with an ITO film pre-deposited onto them. Patterning the electrodes then becomes a subtractive process. In an embodiment, the ITO film may be selectively etched using lithography and hydrochloric acid (HCL). In an embodiment, a mask using polyimide film may be applied to the ITO-PVDF film using laser cutting and tape transfer techniques. The structure is taped to a silicon wafer and submerged in an HCL bath to remove the film. This process enables a fabrication turnaround time of only a few hours with good transparency and favorable sheet resistance. The main drawback to ITO electrodes is their brittleness.

After a patterned electrode on a piezoelectric membrane has been fabricated, it can be adhered to the sidewalls using various adhesion techniques that are suitable to allow vibration of the membrane. Polydimethylsiloxane (PDMS) spin-coating and laser cut double sided tape are two examples.

Spin coated (PDMS) may be used in the case of small transducers on the order of a millimeter or less. First, the base and curing agent are mixed with a 10:1 ratio. The PDMS is then spun onto a piece of PVDF taped to a silicon wafer at 5000 rpm for 60 s. The sidewalls are then placed on top of the PVDF and thin PDMS film, which is then cured at 80° C. for two hours. The PDMS then functions as not just an adhesion layer but also as a membrane layer coupled to the PVDF over the cavities. The main drawback to PMDS is that it isn't suitable for transducers larger than the size of a silicon wafer and it has relatively weak adhesion.

For larger transducers, laser cut double sided tape may be used. Such tape has strong adhesion, but bubbles trapped underneath it may have a negative effect on the transparency. The tape may be cut so that it is not adhered to the PVDF over cavities, otherwise it may reduce the vibration. Due to the limits of laser cutting, it may not be ideal for transducers smaller than ~1 mm. In an embodiment, this tape process may be used with laser cut acrylic sidewalls.

Digital solutions may be used to drive piezoelectric transducer arrays and phase delays may be implemented in software. The interconnect is thus based on metal-oxide-semiconductor field-effect transistors (MOSFETs) and gate drivers. For example, in an embodiment, a 12-element linear array may be implemented using low voltage MOSFETs. The same design can be scaled up for larger arrays running on the digital outputs of an FPGA.

FIG. 3 is a photograph illustrating an embodiment of an array of concentric ring-shaped transducers. FIG. 3 illustrates a top view of an embodiment of a 1×2 array of annular transducer arrays 300, in accordance with the present disclosure. This 1×2 array 300 has two annular transducer arrays 350 and 360 that are functionally similar. For the sake of brevity, first transducer array 350 will be described and it should be taken that second transducer array 360 is functionally similar to array 350. As shown here, arrays 350 and 360 are processed on single substrate and electrical connections at bonding pads 352a-352n and 362a-362n, which may be placed for convenient and/or efficient bonding of electrical connections to a controller (not shown). Annular transducer 350 includes a plurality of concentric transducer rings located in a surface, centered on a point, having an outermost transducer ring 302n, and an innermost transducer ring 302a, where n is an integer. As may be seen here, the outermost and innermost transducer rings may each be driven by circuitry operable to cooperatively provide a mechanical energy field sound pressure level toward a volume in space. There may be additional transducer rings between the innermost transducer ring 302a and the outermost transducer ring 302n, as shown here.

In an embodiment, the array of annular transducers may be implemented as zone plates to produce a mechanical energy focal point in three-dimensional space. In an embodiment, an implementation as a 40 kHz zone plate with a 150 Vpp 40 kHz signal with 200 Hz amplitude modulation allows for high mechanical energy field levels, and in some cases, haptic sensation in some individuals.

FIG. 4 illustrates computational modeling of a 20-ring annular array. Computational modeling was done in MATLAB. In order to simulate an annular array, concentric circles of point sources were used to simulate each annulus. Each circle contained 100 point sources. The other variables were the number of rings, the distance between the rings, the frequency, and the height of the focal point. The time delays were calculated using the following equation:

$${t}_{d} = \frac{{d}_{fp} - {d}_{ref}}{c}$$

Where d_{fp} is the distance from the ring to the focal point, dref is the distance from the center ring to the focal point, and c is the speed of sound, 343 m/s.

The pressure at any coordinate (r, θ) is calculated using the following equation:

$$p ( r , θ , t ) = \frac{{e}^{i ( ω ( t + it ) - kd )}}{d}$$

where ω is the wave velocity, t is the time delay of the point source in seconds, k is the wave number, and d is the distance between the center ring to the coordinate (r, θ). In the modeling, the pressure was calculated in the x-y plane at the chosen focal point. Each additional ring created a tighter focal point above the annular array with higher mechanical energy field.

Driving the annular array. In an embodiment, to connect and drive the annular array, a driver board from STMicroelectronics with 8 channels may be used to drive the annular array. Phased signals may be sent to each annulus of the array. Such may be programmed using STM's ultrasound pulser waveform user interface (UPWUI) where phase delays were calculated in MATLAB and manually programmed into the software. Each annulus may be connected to an impedance matching network from the driver board.

Testing the Transparency. Transparency measurements may be taken using a JDS Uniphase 633 nm laser. Such a laser may be directed through a Thor Labs IS236A integrating sphere. An average power output may be recorded on a Rigol Oscilloscope. The samples may be placed on a Thor Labs ELL20 60 mm linear stage placed in front of the laser. In conducting testing, the lights are desirably turned off to create total darkness. Using such exemplary test equipment and techniques, an exemplary ITO 36-element array transparency was measured to be 91.6%.

To collect the maximum mechanical energy field data, the transducer is desirably driven at its resonance frequency. In order to find the resonance frequency, frequency sweeps may be conducted from 100 Hz to 55 kHz for each sample. In an embodiment, a PMUT sample comprising a 20 mm diameter aluminum electrode single electrode with 12 μm PVDF was measured to have the resonance frequency to be 27 kHz and the maximum mechanical energy field to be 92.8 dB. In an embodiment, a PMUT sample comprising 15 mm diameter aluminum electrode single electrode with 12 μm PVDF was measured to have the resonance frequency to be 33 kHz and the maximum mechanical energy field to be 89 dB. In an embodiment, an aluminum 36-element array which comprising of 15 mm diameter individual elements was measured to have the resonance frequency to be 33 kHz and the maximum mechanical energy field to be 88.2 dB. If the pressure from two sources combines at a focal point, the pressure is doubled from two sources, then the pressure doubles again for two more sources, then four more sources, then 8 additional sources, and so forth. For 32 elements, the pressure doubles 5 times. Each doubling of pressure is +6 dB. We would expect to see about 120 dB at the focal point from the 36-element array.

In an embodiment, a boundary experiment was conducted to determine what percentage of an opening created the best transducers. The perforated sample sweep was 10 seconds with a 15 mm diameter sample, and it was found a resonance frequency of 49.1 kHz. A longer measurement was taken, and it was found that the maximum recorded mechanical energy field was 86.1 dB at 49 kHz. The 100% closed 15 mm sample performed the best with an mechanical energy field of 89 dB while the 75% closed sample, or the perforated sample performed the second best with a mechanical energy field of 86.1 dB. The 25% closed sample performed the worst with a maximum mechanical energy field of 77.7 dB. According to this trend line, the more closed the membrane of the sample is at the boundary of the drum, the higher the maximum mechanical energy field.

In an embodiment, impedance matching experiments were conducted to determine the effect it has on the mechanical energy field, and output data shows that without the impedance matching network, the maximum mechanical energy field was 49.2 dB while with the impedance matching network the maximum mechanical energy field was 66.9 dB.

In an embodiment, acoustic measurements were taken with a 48-microphone array to illustrate the factor that affect the width of the focal point of an acoustic array. The diameter of the transducers strongly affects the resolution of the array. The smaller the diameter, the higher the resonant frequency, which means the smaller the focal point. Additional factors are the gain pattern of the individual transducer, the dimensions of the array as a whole entity, and the distance from the array to the focal point. The gain pattern is dependent on the frequency and the mechanical properties of the transducer itself. If there were no other contributions to the strength of the focal point other than if we were driving the array at the resonance frequency or not, then we would have felt the same level of haptic feedback at every frequency that was not the resonance frequency, however, the frequency changes the gain pattern of the transducer. Higher frequencies are very directional which is why most medical acoustic arrays are in the ultrasonic frequencies usually in the MHz range. As we went lower in frequency we were less and less able to feel haptic feedback according to the power distribution in the gain patterns

It is to be appreciated that there is both a minimum and maximum suitable mechanical energy field intensity to create haptic sensation. Enough force is needed to create tactile sensation, but not so much that temperature-based sensations begin to be felt. Additionally, this sensitivity threshold is dependent on frequency. In fact, different frequencies correspond to different ‘types’ of tactility. In an embodiment, for 40 kHz, a possible level of safe ultrasound exposure for skin is 100 W/cm² or a total force of 428 mN.

In one explanation, tactile sensations are caused by a non-linear effect of focused ultrasound called acoustic radiation force. The radiation force induces a shear wave in the skin tissue, creating a displacement, which triggers the mechanoreceptors within the skin. The maximum displacement u′( ) of a medium induced by radiation force from a pulse of focused ultrasound can be defined as:

$${u}_{max} = \{ \begin{matrix}\frac{α a}{ρ {c}_{l} {c}_{t}} {t}_{0} I , & where {t}_{0} ≪ a / {c}_{t} \\ \frac{α}{ρ {c}_{l} {c}_{t}^{2}} {a}^{2} I = \frac{α}{{c}_{l} μ} {a}^{2} I = kW , & where {t}_{0} ≫ a / {c}_{t}\end{matrix} \qquad ( 1 )$$

where α is the radius of the focal region, to is the duration of the pulse, cₜ is the speed of the shear waves propagation, c₁ is the speed of sound, μ is the shear elastic modulus, α is the absorption coefficient, I and W are the intensity and acoustical power (both averaged over the pulse duration) and k is an amalgamated constant.

Based on the above, larger focal regions and longer pulses lead to a deeper displacement of the skin. Acoustical power (W) is shown to be a significant factor affecting skin displacement and therefore tactile sensation. As acoustic power and mechanical energy field are directly related, this provides one of the metrics to optimize. This displacement equation also introduces a fundamental tradeoff between resolution and mechanical energy field. Larger focal regions (α) generate a greater displacement on the skin. However, the larger the focal point the worse the resolution of the generated tactile image. Note, however, that a modulation scheme that changes this radiation force over time is also relevant as mechanoreceptors are sensitive to change.

Several design parameters may be considered to optimize mechanical energy field for haptic sensation.

To derive the pressure generated by an oscillating membrane at a given point, something called the Rayleigh integral may be used. Based on this, higher frequencies and higher displacements lead to a larger velocity of the membrane. This larger velocity corresponds to a higher pressure. Thus, it leads to the implication that the larger the size of PMUTs, the larger the displacement, and thus the larger the pressure. However, past a certain size PMUTs begin to sag. This sagging counteracts the expected larger displacements. Therefore, there is a upper limit to diameter. In one embodiment, where 500 nm PVDF-TrFE is used, that ideal size was found to be 600 μm.

While there are differences that will make the actual result lower, each element in an array of annular arrays has an approximate linear contribution to the final pressure output. Thus, more elements phased to the same spot means a higher mechanical energy field. However, to reduce the formation of sidelobes the pitch between adjacent elements needs to be smaller than half the wavelength of the resonant frequency. Generally, increasing the density means that the diameter of each individual element is decreased. This is a tradeoff that may be considered.

The thickness of the piezoelectric membrane in an annular array is a characteristic that can be optimized. It is partly what determines the resonant frequency. Generally, a thinner membrane leads to a higher electric field across the membrane, which increases the deflection thereby increasing the output pressure. Also, the greater the piezoelectric coefficient (d33) the greater the deflection and output pressure.

The dielectric breakdown voltage provides a limiting factor for supply voltage. This is also limited by the thickness of the membrane. In other words, the thinner the membrane the less voltage that can be applied before reaching the dielectric breakdown voltage.10 However, PVDF has a very large dielectric breakdown voltage, in the thousands of volts. So, high driving voltages may be an option. In an embodiment, the radius of the top electrode may be smaller than the radius of the membrane.

Annular arrays may have a higher fill factor and better focusing leading to higher mechanical energy field, but other geometries may also be implemented for different optimizations. For example, in an embodiment, Bimorph design increases pressure. A bimorph design involves two piezoelectric elements with four electrodes driven differentially. In an embodiment, PMUTs with venting holes, slits and rings may also be implemented.

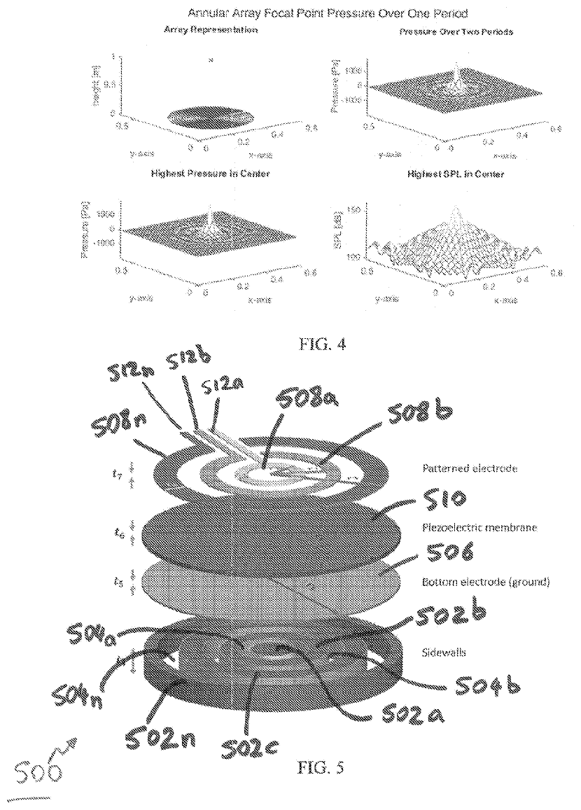

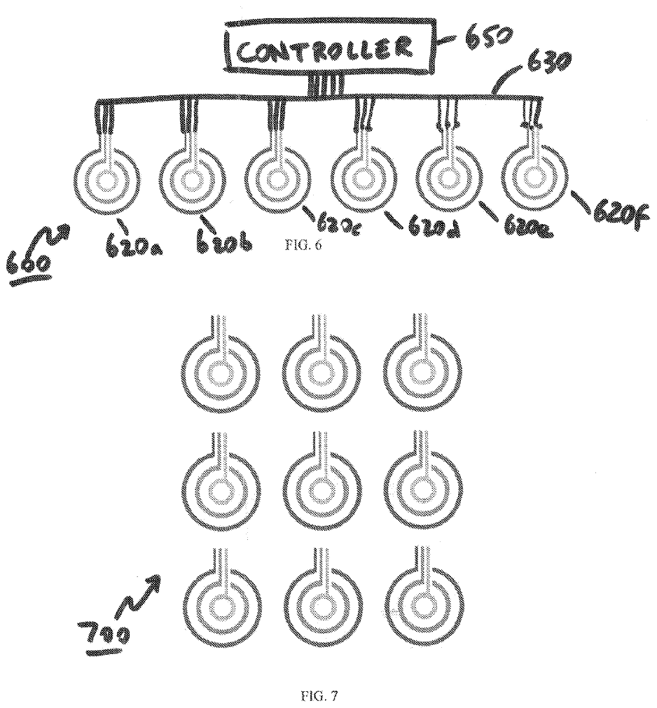

FIG. 5 is an exploded perspective diagram of an exemplary PMUT annular array 500 that provides multiple annular transducer elements that are arranged in concentric rings, in accordance with the present disclosure. In this example, the PMUT annular array 500 has innermost sidewall 502a extending to outermost sidewalls 502n. In this example, innermost sidewall 502a and sidewall 502b define an innermost cavity 504a. Outermost sidewall 502n and sidewall 502c define an outermost cavity 504n. Sidewalls 502b and 502c define a middle cavity 504b. As will be appreciated, and as discussed elsewhere in this specification, there may be many more sidewalls in other embodiments that define further cavities greater than the three described here. A bottom electrode layer 506 may be provided with a radius approximately equal to the radius of the outermost sidewall 502n. Bottom electrode layer 506 is electrically conductive and may provide a common electrical ground connection. Patterned electrodes 508a, 508b, 508n are shaped approximately to provide concentric circular electrodes aligned with the innermost cavity 504a, middle cavity 504b and outermost cavity 504n, respectively. Sandwiched between the patterned electrodes 508a, 508b, 508n is a piezoelectric membrane 510. Piezoelectric membrane 510 may have a similar radius to that of the bottom electrode layer 506. Patterned electrodes, 508a, 508b, and 508n are electrically isolated from each other so that different potential voltages may be applied to each to independently operate each piezoelectric annular transducer element in the annular array 500. Bonding pads (not shown here) may be patterned and electrically connected to electrical traces 512a, 512b, 512n that respectively electrically connect patterned electrodes 508a, 508b, and 508n.

As shown in this exemplary embodiment, concentric ring arrays may have the same thickness per ring. In other embodiments, each ring may have a different thickness for the purpose of designing optimal parameters for haptic performance. Such physical design differences may be computed using mathematical modeling such as MATLAB.

Directionality. In some embodiments, because the focal point can be optimized based on the dimensions, thickness, depth, etcetera of the concentric sidewall rings, larger rings can be used for closer points, smaller rings can be activated for farther points, or a combination thereof, increasing the precision and tune ability of the arrays.

FIG. 6. provides a top view of an exemplary phased array showing a 1×6 array of annular arrays 600. As with the embodiment shown in FIG. 5, each transducer ring is independently controlled and is electrically connected via data bus 630 to a controller 650. The electrical traces extending outward from each annular array 620a, 620b, 620c, 620d, 620e, 620f illustrate the individual connectivity of each annular transducer. As with the above description of the exemplary transducer of FIG. 5, each transducer array is advantageously substantially transparent to visual light passing through.

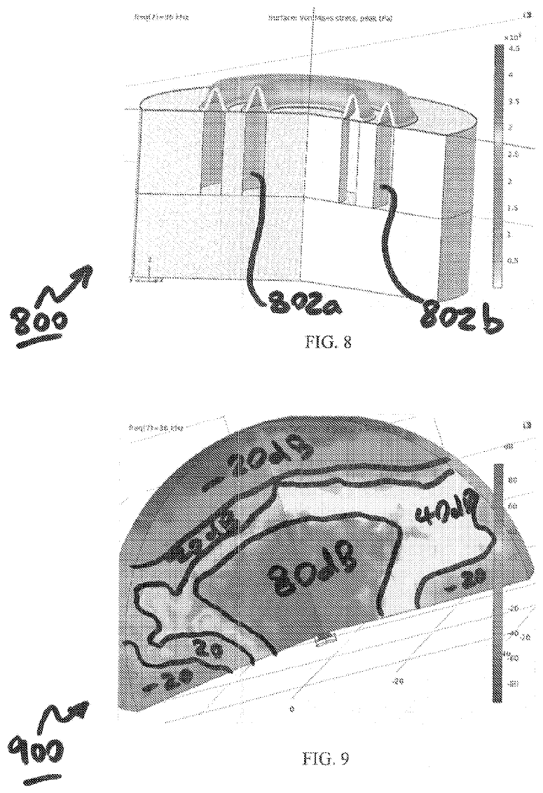

FIG. 7 provides an exemplary 3×3 grid array of annular transducers 700, with each transducer ring being individually connected to and controlled by a controller. Although a 3×3 array of annual transducer arrays is shown as an example, it should be appreciated that any configuration of an m×n grid array may be used, where m and n are integer numbers of 1 or greater and m×n is greater than or equal to 2, where m may or may not equal n.

Fill Factor. Annular arrays have a higher fill factor or density of number of transducers per unit area, so advantageously, they are able to output a higher mechanical energy field for the footprint of space they take up in comparison to known single drum transducers. Additionally, the acoustic modes (e.g., in mode 1 of a drum head) that are available at high power levels may be used. Desirably, use of a simple first mode for the transducers may be used because higher modes may lose more energy in the system. Also advantageously, because each ring may be clamped at the edges, it may allow for higher output in the first mode.

FIG. 8 shows a perspective sectioned diagram of sidewalls of an exemplary annular array 800 in accordance with the present disclosure. This is a simple annular transducer array that has an innermost transducer 802a and an outermost transducer 802b. As may be seen, the sidewalls are desirably perpendicular (vertical) relative to the ground plane of the bottom electrode. However, during processing that creates the sidewalls, they may be slightly sloped by virtue of an etching or 3D printing process. Such processing slope characteristics are known in the art. The physical parameters of the sidewalls may be modeled along with modulating techniques to generate a plot of mechanical energy field vs distance from the transducer.

FIG. 9 is a plot 900 of total mechanical energy field against distance from the transducer annular array when operating outside and inside annular transducer rings 802b, 802a of the design shown in FIG. 8. As expected, this shows that the inner and outside transducer rings 802a, 802b interfere with each other to provide superposition of mechanical energy field at points in space.

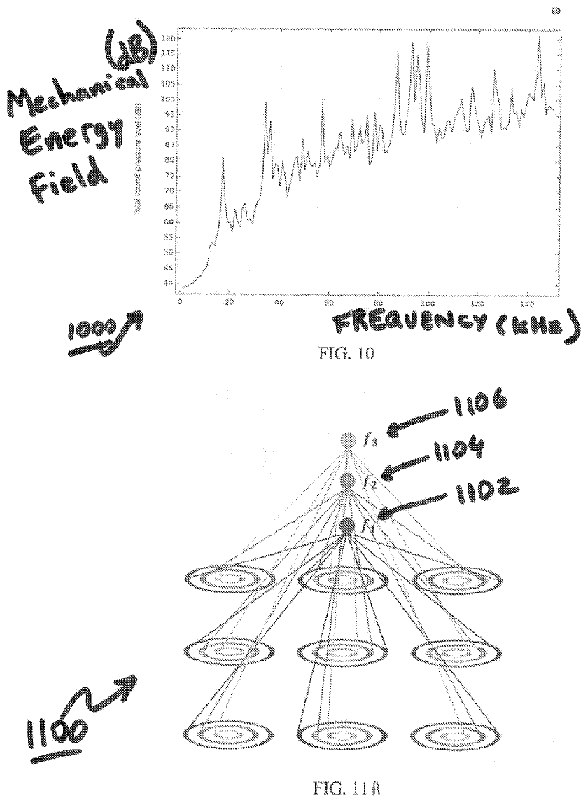

FIG. 10 is a plot 1000 of total mechanical energy field in decibels on the y axis against driving frequency in Kilohertz on the x axis. As can be seen from the plot 1000, for this modeled design, having a resonant frequency of around 36 KHz provides a maximum mechanical energy field. While transducers can operate at any frequency, 1 Hz to over 100 Mhz, if the mechanical energy field is below 20 kHz, a human can hear it, so it is desirable to stay above 24 kHz but below 100 kHz. A human finger will not feel the chosen 36 KHz resonant frequency but it can feel 200 Hz. Thus, the 36 KHz resonant frequency driving an annular transducer element may be modulated at 200 Hz so that the sensation of touch can be perceived by a human touch receptor.

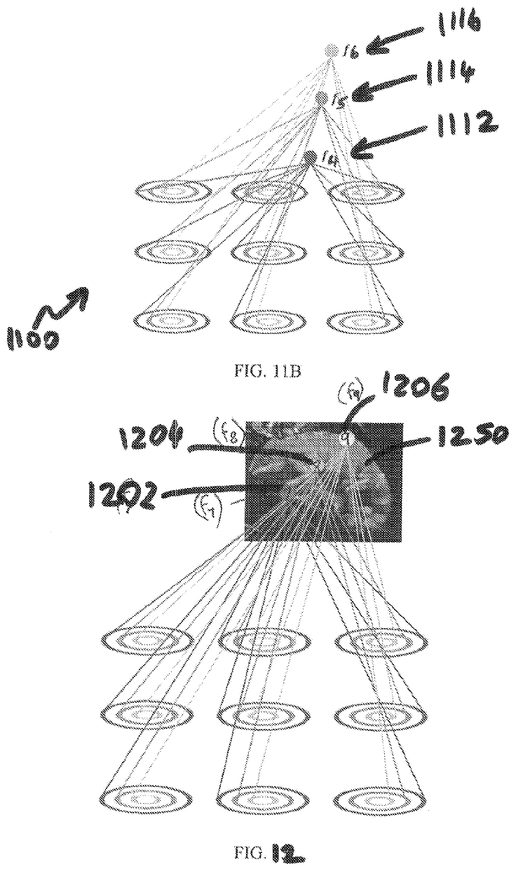

FIG. 11A shows a perspective schematic diagram of a 3×3 array of annular arrays 1100 with an illustration of three exemplary focal points in space where tactile feedback may be transmitted. Here, for example, innermost annular transducer rings in each annular array may be controlled to provide a tactile focal point at volumetric space f1 (1102). Volumetric spaces f1, f2, f3 may be 1 to 5 mm wide in space at a distance z and (x,y) position from an origin located in the plane of the array of annular arrays. Middle annular transducer rings in each annular array may be controlled to provide a second tactile focal point at a second (x,y,z) position from the origin, shown by a tactile focal point at volumetric space f2 (1104). And outer annular transducer rings in each annular array may be controlled to provide a third tactile focal point at a third (x,y,z) position from the origin at volumetric space f3 (1106). Of course, in other embodiments, different diameter rings may interact with other diameter rings to provide different tactile focal points and different magnitudes of mechanical energy field.

FIG. 11B shows a perspective schematic diagram of a 3×3 array of annular arrays 1100 similar to those of FIG. 11A with an illustration of three other exemplary focal points in space where tactile feedback may be transmitted, f4 (1112), f5 (1114), f6 (1116). As the person of skill in the art will appreciate, different combinations of inner, outer and rings therebetween may be activated at different frequencies at any point in time to cooperatively provide desired constructive interference that results in a desired mechanical energy field at a focal position in the (x,y,z) space. Here, this is the case, resulting in three different focal positions f4 (1112), f5 (1114), f6 (1116) in the (x,y,z) space.

FIG. 12 shows a perspective schematic diagram of a 3×3 array of annular arrays with an illustration of three other exemplary focal points in space where tactile feedback may be transmitted spatially and temporally coincident with a holographic image of a chameleon 1250 overlaid thereon. The focal points f7 (1202), f8 (1204), f9 (1206) are coincident with an exemplary wavefront image, here shown as chameleon 1250. Thus, as a person reaches to touch the chameleon in space, the person may observe tactile feedback coincident with a point in space that they visibly observe the lizard. Thus, visual and kinesthetic senses may be stimulated to allow a person to perceive a holographic object in space. Some example systems for providing such visual wavefront images is provided in U.S. patent application Ser. Nos. 17/724,815, 17/776,130, 17/990,258, which are herein incorporated by reference. Additionally, a directional audio output (in human hearing range) may also be steered toward certain points in space coincident with the image and sensory outputs using known techniques for providing directional audio. Such a presentation system may simultaneously provide visual, audio and kinesthetic stimulation of senses.

As used herein, the term “optical wavefront” and related terms are described as follows. Any optical image is made of light: a form of electro-magnetic radiation. Light waves emitted by a point-source spread out in a concentric pattern, propagating as an oscillating energy field. It is convenient to present wave oscillation as a cycle, the full cycle being 360 degrees, or 2π radians. Phase of wave oscillation is, for harmonic sinusoidal wave, defined by o=Asin (2πx/λ), where A is the wave amplitude, defined as the maximum value of wave oscillation, x is the length of wave path from the origin, and A the wavelength of light. A 2-dimensional EM wave is usually presented as a continuous series of subsequent oscillations of electric and magnetic field, each oscillating in its plane, perpendicular one to another (illustration at left). When the plane of oscillation doesn't change, light is linearly polarized (with circularly polarized light, the plane of electric field—with the plane of magnetic field perpendicular to it—rotates in time around its directional axis). Actual waves are generally unpolarized, i.e. their electric field randomly changes its orientation in space, a consequence of the ever changing position and orientation of the emitting atoms. While there is no actual circular motion present, it is convenient, as already mentioned, to represent oscillations as such, with the full phase of a wave—corresponding to the spatial period between two closest points in the same phase—equaling 2π radians. An imaginary surface connecting wave points of identical oscillatory motion, or phase, is called phasefront. Geometrical approximation of the phasefront, based on the identical ray optical path length (OPL) from the source is called optical wavefront, or simply wavefront. Ray, on the other hand, is simply a straight line with the origin at the point-source, that remains perpendicular to the wavefront. While rays are useful in presenting geometrical aspects of optical phenomena, they represent only a tiny fraction of the total energy propagating through the energy field. The wavefront, while itself a geometric category, is more directly related to the underlying physics. It identifies the location of in-phase wave sources, making it the basis for calculations determining the properties of wave interactions at and around focal point. Hence, the significance of the wavefront is in that its form directly determines the quality of optical imaging in a telescope. Obviously, form of the wavefront and geometric properties of the rays are directly inter-related, but the ray geometry remains only loosely related to the interactions taking place within the energy field.

Wave equations define the analytical framework for the propagation of electromagnetic wave. Analytical solution to the wave equations describes a wavefield of a propagating wavefront anywhere in space. However, obtaining an analytical solution for an arbitrary object having arbitrary shape and size is complex and nearly impossible. Instead, a numerical solution of the wave equations may be determined computationally, but even the computational determination can be time consuming and impractical. As such, various approximation model can be derived and used to simplify the computational determination of the numerical solution of the wave equations.

In one approach, the solution to vectoral wave equations is approximated by making certain assumptions to reduce the wave equations to scalar components. These integral equations are scalar in nature and hence are also called as scalar diffraction formulas. These approximated solutions based on scalar diffraction can be referred to as the “scalar theory” and can simplify computational determination of a hologram with satisfactory resolution and accuracy in holographic display applications.

The starting point of the scalar diffraction theory are the Maxwell equations that describe an electromagnetic energy wave. When it is assumed that an electromagnetic energy wave is propagating in a linear, uniform, isotropic, homogeneous, and non-dispersive material, the vector wave equation 1.1 below can be derived from the Maxwell equations to describe the electric field component:

$${∇}^{2} E = {μ}_{0} {ϵ}_{0} {ϵ}_{r} \frac{{d}^{2}}{{dt}^{2}} E \qquad ( 1.1 )$$

where ϵ₀ is the permittivity of vacuum, ϵᵣ is a relative permittivity, and μ₀ is the permeability of vacuum.

Since light behaves like a wave, the vector wave equation 1.1 can be written in the form of a scalar wave equation 1.2:

$${∇}^{2} u ( p , t ) - \frac{1}{{c}^{2}} \frac{{d}^{2} u ( p , t )}{{dt}^{2}} = 0 \qquad ( 1.2 )$$

where c is the speed of the wave in a dielectric media. Comparing the vector wave and scalar wave equations 1.1 and 1.2, the speed of light is can be written as:

$$c = 1 / \sqrt{{μ}_{0} {ϵ}_{0} {ϵ}_{r}} = \frac{{c}_{0}}{n} \qquad ( 1.3 )$$

where c₀ is the speed of light in vacuum and equal to 1/\sqrt{μ₀ϵ₀}, and n is the refractive index and equal to \sqrt{ϵᵣ}.

The component u(p,t) can be considered as a wave function defining a scalar field component at the given position p and time t in a material having the refractive index n. For a monochromatic wave, the scalar field function can be written as a complex amplitude according to equation 1.4:

$$u ( p , t ) = Re \{ U ( p ) {e}^{- i ω t} \} \qquad ( 1.4 )$$

where ω is the cyclic frequency of the light and is equal to 2πν.

The function U(p) is referred to as a complex amplitude given by equation 1.5:

$$U ( p ) = A ( p ) {e}^{i ϕ ( p )} \qquad ( 1.5 )$$

wherein A(p) is a real value that can be understood as the amplitude and φ(p) can be understood as the phase of the complex amplitude. The complex amplitude U(p) is a three-dimensional function, and its two-dimensional distribution in a given plane is referred to as a wavefield.

Substituting equations 1.4 and 1.5 into the wave equation in equation 1.2, the wave equation can be rewritten in the same form as the Helmholtz equation:

$${∇}^{2} U ( p ) + {k}^{2} U ( p ) = 0 \qquad ( 1.6 )$$

where λ is the wavelength of light, and k is equal to 2π/λ and referred to as a wave number.

In the context of rendering a wavefront, the object wave, the reference wave, and the signal wave can be modeled as plane waves or spherical waves based on the wave equations discussed above. Plane waves have planar wavefronts, have a constant frequency and amplitude, and extend indefinitely. However, for a given space, any complex wavefront can be modeled as one or more local plane wave. The solution to the wave equations above for a plane wave is:

$$u ( p , t ) = A cos ( \vec{k} \cdot \vec{p} - ω t + {φ}_{0} ) \qquad ( 1.7 )$$

where φ₀ is a constant defining the phase of the cosine function at time t=0 and at r=0, \vec{p} is a position vector, and \vec{k} defines a wave vector pointing in the direction of propagation with a length

$$\vert \vec{k} \vert = \frac{2 π n}{λ 0}$$

in which λ₀ is the wavelength of the light in vacuum.

Based on equations 1.4 and 1.5, the complex amplitude of a plane wave described by equation 1.7 can be written as:

$$U ( p ) = A {e}^{i ( \vec{k} \cdot \vec{p} + φ 0 )} \qquad ( 1.8 )$$

In Cartesian coordinates, the wavefield of a plane wave at z=z₀ is:

$$U ( x , y ; {z}_{0} ) = A {e}^{i ( {k}_{x} x , + {k}_{y} y + {k}_{z} {z}_{0} + φ 0 )} \qquad ( 1.9 )$$

Spherical waves are emitted from a single point source and have spherical wavefronts. The solution to the wave equations above for a plane wave is:

$$u ( p , t ) = A / r cos ( kr \pm ω t + {φ}_{0} ) \qquad ( 1.1 )$$

where r is the radial distance in a spherical coordinate system and can be determined based on Cartesian coordinates, x, y, z as shown in equation 1.11:

$$r = \vert p \vert = \sqrt{{x}^{2} + {y}^{2} + {z}^{2}} \qquad ( 1.11 )$$

Based on equations 1.4 and 1.5, the complex amplitude of a spherical wave described by equation 1.10 can be written as:

$$U ( p ) = A / r {e}^{\pm i ( kr + φ 0 )} \qquad ( 1.12 )$$

In Cartesian coordinates, the wavefield of a spherical wave at z=z₀ is:

$$U ( x , y ; {z}_{0} ) = A / r {e}^{\pm i ( kr + φ 0 )} \qquad ( 1.13 )$$

$$where$$

$$r = \sqrt{{x}^{2} + {y}^{2} + {z}_{0}^{2}} \qquad ( 1.14 )$$

Based on equations 1.9 and 1.14, a wavefield can be sampled at various (x, y) positions at the z=z₀ plane for a plane wave or a spherical wave, respectively.

An energy wave in free space according to the assumptions of the scalar theory is described by the wave equations 1.2 and 1.6, and the plane and spherical waves discussed above are specific solutions to the wave equations 1.2 and 1.6. Boundary conditions can help solve the wave equations 1.2 and 1.6 to provide a more general solution for a wave that propagates in free space. When light is diffracted by an aperture, the boundary condition can be understood to be a binary function, in which the value of the function is unity inside the aperture and zero outside the aperture. In an embodiment, the a wavefield defined by a first complex amplitude in a first plane can be used as the boundary condition for solving the wave equations 1.2 and 1.6 to obtain a diffracted wavefield defined by a second complex amplitude in a second plane at any location in a 3D space. In an embodiment, a computational implementation of this process may be referred to as numerical field propagation and include the steps of sampling a source wavefield (i.e., the first amplitude) and using it as a boundary condition to numerically solve the wave equations to simulate the destination/diffracted field (i.e., the second complex amplitude).

The propagation of wavefield can be modelled according to a number of diffraction formulations known in the art, including Fresnel-Kirchhoff diffraction and Rayleigh-Sommerfeld diffraction. Both Fresnel-Kirchhoff formulation and Rayleigh-Sommerfeld formulation have been derived and described extensively in the art, and thus detailed derivation will not be repeated here.

The Fresnel-Kirchhoff diffraction formulation relies on Green's identities to express the disturbance at an arbitrary point P as a function of the values of the solution of the wave equation and its first order derivative at all points on an arbitrary surface which encloses P. Its most general form can be written as equation 1.15 below:

$$U ( P \text{?} ) = \frac{1}{4 π} {\int \int }_{S + S} \text{?} ( \frac{\partial U}{\partial n} G - U \frac{\partial G}{\partial n} ) ds , \qquad ( 1.15 )$$

$$where G = \frac{exp ( {jkr}_{01} )}{r \text{?}}$$

$$\text{?} \text{indicates text missing or illegible when filed}$$

where U is the complex amplitude of the disturbance at the surface, and s is the distance from P to the surface.

In the coordinate system in FIG. 8, the Fresnel-Kirchhoff formulation can be written as equation 1.16 below:

$$U ( x , y ; z ) = - \frac{i}{λ} \int U ( {x}^{′} , {y}^{′} ; 0 ) \frac{{e}^{ikr}}{r} \frac{( 1 + cos )}{2} {dx}^{′} {dy}^{′} \qquad ( 1.16 )$$

where r=[x−x′)²+(y−y′)²+z²]^{1/2}, and x is the diffraction angle at point (x′, y′, 0) between the diffracted wave and the normal of the z=0 plane. The Fresnel-Kirchhoff formulation is an approximate scalar solution of the Helmholtz equation that is generally accurate unless very close to the aperture. The component

$$\frac{( 1 + cos )}{2}$$

in equation 1.16 is also known as the obliquity factor and can be approximated to be 1 when the diffraction angle is small.

Determining a solution for the integral in equation 1.16 can be challenging for most applications, and certain assumptions can be made for r in equation 1.16 to derive approximated diffraction models known in the art that are easier to solve either analytically or numerically.

For example, Fresnel approximation is a known approximation model that can simplify equation 1.16 by making several approximations. The first approximation is based on the assumption that the diffraction angle is small, and thus the component

$$\frac{( 1 + cos χ )}{2}$$

in equation 1.16, which is also known as the obliquity factor, can be approximated to 1. The assumption that the diffraction angle is small also allows the approximation of r in the denominator

$$of \frac{{e}^{ikr}}{r} to be z .$$

However, in the exponent

$$of the \frac{{e}^{ikr}}{r} ,$$

a small variation in r can significantly change the value of e^{ikr}. Thus, a more accurate approximation of r can be made by assuming z>>(x−x′)²+(y−y′)² truncating the expansion of r=[x−x′)²+(y−y′)²+z²]^{1/2} according to equation 1.17:

$$r \approx z + \frac{{( x - {x}^{′} )}^{2} + {( y - {y}^{′} )}^{2}}{2 z} \qquad ( 1.17 )$$

The Fresnel diffraction integral in equation 1.17 can be derived from the above assumptions:

$$U ( x , y ; z ) = \frac{{e}^{ikz}}{i λ z} \int U ( {x}^{′} , {y}^{′} ; 0 ) {e}^{\frac{ik}{2 z} [ {( x - {x}^{′} )}^{2} + {( y - {y}^{′} )}^{2} ]} {dx}^{′} {dy}^{′} \qquad ( 1.18 )$$

The Fresnel diffraction integral can be solved using various numerical techniques known in the art, including fast Fourier transforms.

The Fraunhofer approximation is another approximation that can simplify the Fresnel-Kirchhoff diffraction formula. As a diffraction pattern continuously evolves along the z-direction, at a distance far from the aperture, it eventually evolves into a final diffraction pattern that maintains itself as it continues to propagate (although it increases its size in proportion to distance). This far-away diffraction pattern in a far field is described by the Fraunhofer approximation. This is the limiting case of the Fresnel approximation when the field is observed at a distance far after the aperture.

Equation 1.18 can be expanded into equation 1.19 below,

$$U ( x , y ; z ) = \frac{{e}^{ikz}}{i λ z} \int U ( {x}^{′} , {y}^{′} ; 0 ) {e}^{\frac{ik}{2 z} [ ( {x}^{2} + {y}^{2} ) - 2 ( {xx}^{′} + {yy}^{′} ) + ( {x}^{′2} + {y}^{′2} ) ]} {dx}^{′} {dy}^{′} \qquad ( 1.19 )$$

and in far field condition (z>>k/2), the exponential component

$${e}^{\frac{ik}{2 z} ( {x}^{′2} + {y}^{′2} )}$$

in equation 1.19 can be approximated to be 1, resulting in the Fraunhofer diffraction integral as shown in equation 1.20 below:

$$U ( x , y ; z ) = \frac{{e}^{ikz} {e}^{\frac{ik}{2 z} [ ( {x}^{2} + {y}^{2} )}}{i λ z} \int U ( {x}^{′} , {y}^{′} ; 0 ) {e}^{\frac{ik}{z} ( {xx}^{′} + {yy}^{′} )} {dx}^{′} {dy}^{′} \qquad ( 1.2 )$$

The Fraunhofer integral can be interpreted as a two-dimensional (inverse) Fourier transform on the source wave field U(x′, y′; 0) where kx/z and ky/z can be considered as spatial frequencies.

The above discussed Fresnel and Fraunhofer approximations can also be applied to Rayleigh-Sommerfeld formulation of diffraction. Compared to the Fresnel-Kirchhoff formulation, the Rayleigh-Sommerfeld formulation provides more rigorous solutions in equations 1.21 (first solution) and 1.22 (second solution) using two different boundary conditions.

$${U}_{1} ( {P}_{0} ) = \frac{1}{2 π} {\int \int }_{\sum } U \frac{\partial {G}_{K}}{\partial n} ds \qquad ( 1.21 )$$

$$and$$

$${U}_{U} ( {P}_{U} ) = \frac{1}{2 π} {\int \int }_{\sum } \frac{\partial U}{\partial n} {G}_{K} ds \qquad ( 1.22 )$$

In the coordinate system in FIG. 8, the first solution to the Rayleigh-Sommerfeld formulation can be written as equation 1.23 below:

$$U ( x , y ; z ) = \int U ( {x}^{′} , {y}^{′} ; 0 ) \frac{{e}^{ikr}}{r} \frac{z}{r} ( \frac{1}{2 π r} + \frac{1}{i λ} ) {dx}^{′} {dy}^{′} \qquad ( 1.23 )$$

Applying the same assumptions in the Fresnel approximation discussed above, (i.e., r≈z for the non-exponential components and

$$r \approx z + \frac{{( x - {x}^{′} )}^{2} + {( y - {y}^{′} )}^{2}}{2 z}$$

in the exponential component), equation 1.23 can be simplified to equation 1.24:

$$U ( x , y ; z ) = \frac{{e}^{ikz}}{i λ z} \int U ( {x}^{′} , {y}^{′} ; 0 ) {e}^{[ \frac{i π}{λ z} {( x - {x}^{′} )}^{2} + {( y - {y}^{′} )}^{2} ]} {dx}^{′} {dy}^{′} \qquad ( 1.24 )$$

From the Fresnel approximation in equation 1.24, the Franhofer approximation can be applied similarly to further simply equation 1.24 to

$$U ( x , y ; z ) = \frac{{e}^{ikz} {e}^{[ \frac{ik}{2 z} ( {x}^{2} + {y}^{2} )}}{i λ z} \int U ( {x}^{′} , {y}^{′} ; 0 ) {e}^{- \frac{ik}{z} ( {xx}^{′} + {yy}^{′} )} {dx}^{′} {dy}^{′} \qquad ( 1.25 )$$

The Rayleigh Sommerfeld formulation is a more rigorous model than the Fresnel Kirchhoff formulation because of the former's the mathematical consistency and the latter's ability to reproduce closely the diffracted field right behind the aperture. However, the Rayleigh Sommerfeld formulation is limited by its assumption of a plane surface, and the Fresnel Kirchhoff formulation can handle surfaces of any shape, thereby allowing for more accurate propagations in optical applications.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It will be understood that the principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically, and by way of example, although the headings refer to a “Field of Invention,” such claims should not be limited by the language under this heading to describe the so-called technical field. Further, a description of technology in the “Background of the Invention” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. In general, but subject to the preceding discussion, a numerical value herein that is modified by a word of approximation such as “about” may vary from the stated value by at least ±1, 2, 3, 4, 5, 6, 7, 10, 12 or 15%.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result. Words relating to relative position of elements such as “near,” “proximate to,” and “adjacent to” shall mean sufficiently close to have a material effect upon the respective system element interactions. Other words of approximation similarly refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the desired characteristics and capabilities of the unmodified feature. As used here, the term “substantially transparent” means that 90% of the light incident on a substantially transparent object can pass through.

The term “or combinations thereof” as used herein refers to all permutations and combinations of the listed items preceding the term. For example, “A, B, C, or combinations thereof is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims.

What is claimed is:

1. An annular transducer array comprising:
a plurality of concentric transducer rings located in a surface, centered on a point, having an outermost, and an innermost transducer ring;
wherein the outermost and innermost transducer rings are each driven by circuitry operable to cooperatively provide a mechanical energy field toward a volume in space.

2. The annular transducer array of claim 1, wherein the transducer rings are substantially transparent to electromagnetic energy comprising a modulated wavefront.

3. The annular transducer array of claim 2, wherein the modulated wavefront is modulated light.

4. The annular transducer array of claim 1, wherein the modulated wavefront is a spatially modulated wavefront.

5. The annular transducer array of claim 4, wherein the modulated wavefront is provided by one of a spatial light modulator (SLM) or a wavefront modulator.

6. The annular transducer array of claim 1, wherein the mechanical energy field is directional.

7. The annular transducer array of claim 1, wherein the surface is coplanar.

8. The annular transducer array of claim 1, wherein the transducer is substantially transparent.

9. The annular transducer array of claim 1, wherein greater than 50% of incident modulated wavefront light passes through unattenuated.

10. The annular transducer array of claim 1, wherein each concentric transducer ring has a predetermined resonant frequency

11. The annular transducer array of claim 10, wherein the resonant frequency is the same in the innermost transducer ring and the outermost transducer ring.

12. The annular transducer array of claim 10, wherein the resonant frequencies are different in the innermost transducer rings and the outermost transducer rings.

13. The annular transducer array of claim 1, wherein the resonant frequency of the concentric transducer rings is greater than 20 KHz.

14. The annular transducer array of claim 13, wherein the concentric transducer rings are further modulated at a frequency between 100 Hz to 250 Hz.

15. The annular transducer array of claim 1, further comprising additional rigs between the outermost and innermost transducer rings that are also each driven by circuitry.

16. The annular transducer array of claim 1, wherein the volume in space is a volume having a diameter in the range 1 mm to 5 mm.

17. The annular transducer array of claim 1, wherein the transducer rings are annular in shape.

18. The annular transducer array of claim 1, wherein the transducer is a micromachined ultrasonic transducer.

19. The annular transducer array of claim 18, wherein the micromachined ultrasonic transducer is one of a capacitive micromachined ultrasonic transducer and a piezoelectric micromachined ultrasonic transducer.

20. The annular transducer array of claim 1, wherein each transducer ring generates a mechanical energy field independent of other transducer rings in the annular transducer array.

21. The annular transducer array of claim 20, wherein selective driving of transducer rings in the annular transducer array provides directional control of the mechanical energy field.

22. The annular transducer array of claim 1, wherein activation of a plurality of rings in the annular array provides focal control of the mechanical energy field.

23. The annular transducer array of claim 1, wherein control parameters for each transducer ring are selected from the group of changing the drive frequency, phase delay, timing, and wave structure.

24. The annular transducer array of claim 23, wherein the wave structure is selected from the group of Bessel, sine, square, or superposition of waves.

25. The annular transducer array of claim 1, wherein each transducer ring is operable to have a different output level that can contribute to increasing the mechanical energy field for one direction and reducing the mechanical energy field in another direction.

26. The annular transducer array of claim 1, wherein the spacing between each transducer ring and thickness of each transducer ring is selected to define a mechanical energy field output and a resonance frequency.

27. The annular transducer array of claim 1, wherein the transducer rings are driven with spatiotemporal modulation operable to raster the mechanical energy field focal point at a first point in space multiple times per second.

28. The annular transducer array of claim 27, wherein the transducer rings are driven with spatiotemporal modulation operable to raster the sound focal point at a second point in space multiple times per second.

29. The annular transducer array of claim 1, wherein the transducer rings are driven with amplitude modulation operable to focus a sound focal point at a first point in space.

30. The annular transducer array of claim 1, wherein the transducer rings are driven with amplitude modulation and spatiotemporal modulation.

31. An annular transducer array comprising:
annular sidewalls having concentric rings centered on a point;
a bottom electrode attached to the annular sidewalls;
a plurality of patterned electrodes arranged in concentric rings,
a piezoelectric membrane between the bottom electrode and the plurality of patterned electrodes,
wherein the piezoelectric membrane is operable to resonate between respective concentric rings in cooperation with a drive signal respectively applied to each patterned electrode.

32. A haptic device, comprising:
a substrate;
sidewalls extending from the substrate and defining a cavity;
a membrane coupled to the sidewall and positioned over the cavity; and
electrodes operable to apply a voltage across the membrane;
wherein the membrane is operable to be vibrated due to the voltage and to generate mechanical energy towards a focal point in space.

33. The haptic device of claim 1, wherein the electrodes form an annular array pattern on the membrane.

34. An array of annular transducer arrays of claim 1, the array having at least two annular transducer arrays.

35. The array of annular transducer arrays of claim 34, further comprising a controller operable to control the transducer rings to direct the mechanical energy field toward the volume in space.

36. The array of annular transducer arrays of claim 1, wherein the array is substantially transparent.
